(19) United States
(12) Patent Application Publication
(10) Pub. No.: US 2017/0067982 A1
(43) Pub. Date: Mar. 9, 2017

(54) METHOD AND APPARATUS FOR CROSS DEVICE AUTOMATIC CALIBRATION

(71) Applicant: lntel Corporation, Santa Clara, CA (US)

(72) Inventors: Xiaoyong Pan, Shanghai (CN); Justin Lipman, Shanghai (CN); Lei Yang, Hillsboro, OR (US); Xue Yang, Arcadia, CA (US); Yong Qually Jiang, Shanghai (CN)

(73) Assignee: lntel Corporation, Santa Clara, CA (US)

(21) Appl. No.: 15/039,651

(22) PCT Filed: Dec. 26, 2013
(86) PCT No.: PCT/US13/77841

§ 371 Date: May 26, 2016

(51) Int. Cl. G01S 5/02

(52) U.S. Cl. CPC G01S 5/0252; G01S 5/021

(57) ABSTRACT

The disclosure relates to automatic calibration for cross devices in Wi-Fi fingerprint based areas. In an exemplary embodiment, an online device scans and obtains multiple signal strength value (RSSI^{o}ᵢ) from local access points. The online device may access a fingerprint database and obtain a set of fingerprints. Each fingerprint includes a known location, a set of RSSI values (RSSI^{f}ᵢ) and optionally a device/model name. For each fingerprint, the online device: (1) calculates a fingerprint RSSI offset (fpOff) in real-time; (2) applies the fingerprint RSSI offset (fpOff) to the fingerprint RSSI values to determine adjusted fingerprint values. Then the online device identifies fingerprints with minimum Euclidean distance and uses their RSSI offset (fpOff) value to determine a device RSSI offset value. The device offset value can be used to calibrate the online device and to provide accurate location information.

### BACKGROUND

Field

The disclosure relates to a method, system and apparatus for cross device automatic calibration. Specifically, the disclosure relates to automatic calibration for cross devices in a Wi-Fi fingerprint-based environment.

Description of Related Art

Locating people, animals and mobile terminals inside a structure is becoming more important. The structure can be a covered structure inaccessible by conventional Global Positioning Systems (GPS). Conventional indoor geo-location techniques rely on information including received signal strength indication (RSSI), angle of arrive (AOA), time of arrival (TOA) and time differences of arrival (TDOA). The signal information is then manipulated to determine transmitter location inside a structure or to compile a so-called structure fingerprint.

Wi-Fi fingerprinting is a technique for locating a mobile device by matching an observed set of signal strength measurements (Received Signal Strength Indication, RSSI) obtained by a mobile device from multiple wireless access points (APs), to a known set of similar signal strength values in a location fingerprint database. The process includes two phases: an offline phase and an online phase.

In the offline phase, an area is divided into fingerprint cells. For each cell, RSSI from Wi-Fi APs are scanned from a mobile device and stored in a fingerprint database. In the online phase, the set of observed RSSI values scanned from a mobile device is compared to those in the fingerprint database. The cells where fingerprint RSSI values are closest to the observed RSSI values are selected as the estimated location of the mobile device. The selection of closest cells/fingerprints can use a technique of K-Nearest Neighbor (K-NN) based on Euclidean distance.

The K-NN approach works well when the device used in the online phase is the same model as the device used in the offline phase. However when the devices are different models (even if from the same manufacturer), the fingerprint RSSI values may have significant difference with the observed RSSI values. This is true even when the signals are received at the same location. Consequently, the closest sets of fingerprint RSSI values are selected incorrectly and the location determination is wrong. In order to solve this problem, many fingerprinting solutions require manual calibration from the end user or the service provider. The manual calibration detracts from user experience and increases deployment cost.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 shows fingerprint location errors for ten random locations;

FIG. 2 shows fingerprint location errors at ten random locations after the online device was manually calibrated;

FIG. 3 shows the results of a real-time fingerprint location errors using the real-time implementation according to one embodiment of the disclosure;

FIG. 4 is an exemplary table showing different RSSI offsets (in dBm) for different devices;

FIG. 5A shows an exemplary flow diagram for implementing one embodiment of the disclosure;

FIG. 5B shows an exemplary flow diagram for a simplified implementation of FIG. 5A;

FIG. 6 schematically illustrates an exemplary device for implementing an embodiment of the disclosure;

FIG. 7 is a schematic representation of an exemplary network for implementing the disclosed principals;

FIGS. 8A shows location measurement for an uncalibrated online device;

FIG. 8 B shows location measurement for a calibrated online device; and

FIG. 9 shows an exemplary system for implementing the disclosure.

### DETAILED DESCRIPTION

An embodiment of the disclosure relates to a method and apparatus for detecting a device location in an enclosed environment. The enclosed environment may be covered or uncovered space. The location determination can be done by a mobile device seeking its location, or it can be sent to another device (another mobile, a server or an access point) for location determination.

Conventionally, a wireless device interested in determining its location (hereinafter, online device) searches for the best match (e.g., closest location) on the Wi-Fi fingerprint database. A fingerprint database typically covers an entire floor with many cells (e.g., one fingerprint every one or four square meters). Once the online device's location is determined it can be added to the fingerprint database to further develop the map. Recent studies shows that any difference between the offline device and online device increase location error. That is, make, model and type difference between the online and offline device adversely affects location determination.

The disclosed embodiments apply mathematical relationship and between the online device and the offline device to characterize various offsets affects. To describe the various offsets, reference is made to the following definitions which are applied throughout the specification. Calibration is the process of determining the RSSI offset between an online and an offline device. During calibration, the online device scans for all observable APs. The Wi-Fi scanning is called an observation and results in identifying a set of observation RSSI (RSSI^{o}) values for all observable APs {<APi, RSSIi>}. An offline fingerprint is obtained when an offline device conducts Wi-Fi scans at a known location and identifies one or more APs. The fingerprint scan results in collecting fingerprint RSSI (RSSI^{f}) values for each AP: <location, {<APi, RSSi>}. Thus, a location fingerprint can have a set of RSSI values {<APi, RSSI>} from one or more visible APs. The fingerprint data can be stored at a database. An online device can retrieve a set of fingerprints from a database and compare them to data collected during an observation in order to find the fingerprint(s) whose RSSI values are most similar (or closest) to the RSSI values in the observation.

The RSSI offset between an offline device and an online device is known as the device offset (devOff). The value of devOff can be determined from a manual calibration or from auto calibration techniques disclosed herein. Observation offset (obsOff) is the RSSI offset between an offline device and an online device based on an observation (i.e., a set of RSSI values from a Wi-Fi Scan) by the online device. Fingerprint offset (fpOff) is the RSSI offset between a set of RSSI values of a fingerprint data collected by an offline device and a set of RSSI values collected during an observation by the online device. Access point offset (apOff) is defined as the RSSI difference between a RSSI value from an AP in a fingerprint on an offline device and a RSSI value from same AP collected during an observation by the online device.

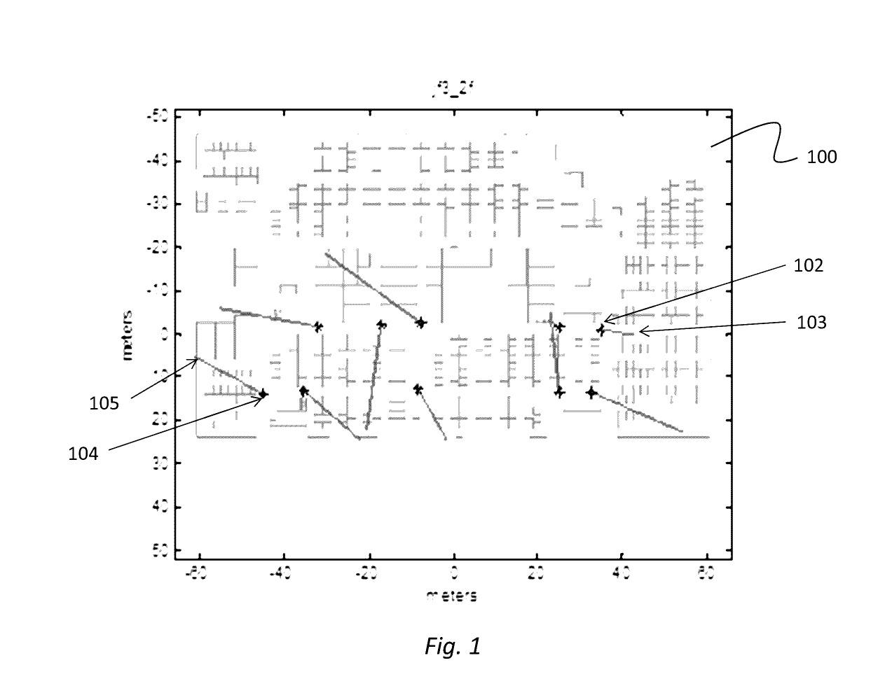

FIG. 1 shows fingerprint location errors for ten random locations. Specifically, FIG. 1 shows indoor environment 100 having ten randomly selected locations. The locations are randomly selected throughout an area. The area can be subdivided into multiple cells (not shown) such that one or more of the locations fall within one cell. A Wi-Fi fingerprint database (not shown) was generated using Samsung Galaxy Tablet 10.1® as the offline device. A Samsung Galaxy S3 phone® was selected as the online test device. From a manual calibration it was determined that the online device had about −9 dB RSSI offset from the offline device. However, the online device was not calibrated for this test. When the online device was used at the 10 randomly selected test points (locations marked x) a significant location error was observed. For example, the online device identified location 103 as the online device location when it was actually at location 102 (an error of about 8 meters). Similarly, location 105 was identified as the online device location when it was actually at location 104 (an error of about 15 meters). Similar error was found for the remaining 8 random locations in FIG. 1. It can be readily seen that if the online device is not calibrated appropriately, the determined location can be as far as a few meters off at any direction.

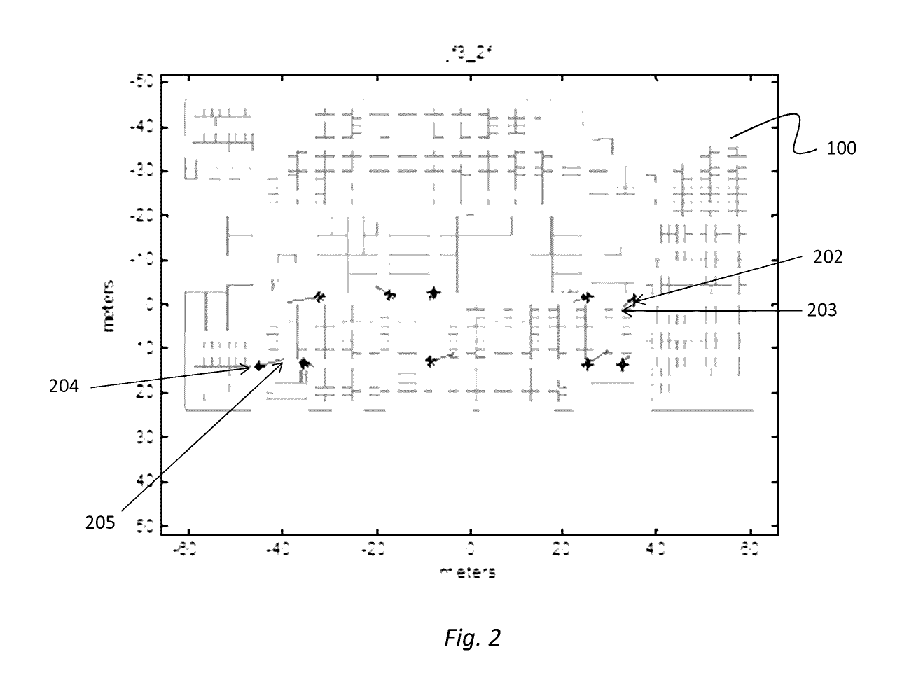

FIG. 2 shows fingerprint location errors at ten random locations after the online device was manually calibrated. In FIG. 2, Environment 100 was used with the same online device. For this experiment the online device was manually calibrated to accommodate for the −9 dB RSSI offset discussed above. As seen from FIG. 2, the location error was significantly less than that of FIG. 1. Specifically, measured location 203 was about 2 meters off from the actual location 202 and measured location 205 was about 4 meters off from actual location 204. Manual calibration, however, detracts from user experience and increases deployment cost.

To overcome these and other deficiencies, an embodiment of the disclosure provides a method, system and apparatus to provide automatic, real-time, device calibration and location estimation. Accordingly, an online device can obtain a set of fingerprint RSSI values from a database. Each fingerprint includes a known location and a set of RSSI values (RSSI^{f}ᵢ). Each fingerprint may optionally include device and/or model name for the offline device used for collecting the fingerprint data. The online device can also obtain a set of observed RSSI values from multiple observable APs. The multiple APs may belong to a cell or to the larger area under study. For each set of fingerprint and observed RSSI values, the calibration and location determination can be implemented by: (1) calculating a real-time device RSSI offset by analyzing the fingerprint RSSI values and the observed RSSI values; (2) applying the device RSSI offset to the fingerprint RSSI values in the set; and (3) comparing the adjusted fingerprint RSSI values with the observed RSSI values; and (4) selecting the cell(s) having an adjusted RSSI value closest to the observed RSSI value as the estimated device location.

In another embodiment, the online device scans and identifies multiple APs. The online device measures an observed signal strength value (RSSI^{o}) from each AP. The online device may obtain a set of observed signal strength values (e.g., RSSI^{o}₁, RSSI^{o}₂ . . . RSSI^{o}ₘ) from different APs during a Wi-Fi scan. The online device may continuously conduct Wi-Fi scan to obtained RSSIs from observable APs. For example, the online device may scan every second. The online device also accesses a fingerprint database to obtain a set of fingerprints. The fingerprint database may be local or external. For example, the fingerprint data may be populated by different devices and stored on the cloud. Each fingerprint provides a set of RSSI values collected at a known location during the offline stage (e.g., RSSI^{f}₁, RSSI^{f}₂ . . . RSSI^{f}ₘ).

For each fingerprint, the online device: (1) calculates an RSSI offset (fpOff) in real-time by analyzing the fingerprint RSSI^{f} values and the observed RSSI^{o} values; (2) applies the RSSI offset (fpOff) to the fingerprint RSSI values to calculate a Euclidean distance between the adjusted fingerprint RSSI values and the observed RSSI values; (3) identifies one or multiple fingerprints which have minimum Euclidean distance to current observation. These fingerprints' corresponding (fpOff) can be candidates for determining RSSI offset (obsOff) between offline and online device from current observation; (4) determines an RSSI Offset (devOff) between the offline and online devices by weighted averaging the RSSI offset (obsOff) value from its current observation, historical offset from previous observations and/or RSSI offset between the two devices in a cloud contributed by other devices with same model; (5) applies the offset (devOff) value to each fingerprint RSSI values, re-calculate the Euclidean distance between the fingerprint and current observation, and select one or multiple fingerprints with minimum Euclidean distance to estimate the location of the device (k-NN). The locations or cells whose adjusted fingerprint RSSI values are closest to the observed RSSI values can be selected as the estimated location of the device.

In another exemplary implementation, the fingerprint data set for a floor plan is retrieved from a database. As stated, the fingerprint data may be collected with one or more offline devices and stored at a database. The fingerprint dataset may include a number of fingerprint signal strengths:

{fpi}, i=1, 2, . . . m (1)

In equation (1), m is the number of cells (fingerprints) for the floor. For each fingerprint:

FP=<location, RSSIs, device> (2)

In equation (2), location defines the cell location where the fingerprint was obtained; device is the device/model on which the fingerprint was done (i.e., the offline device); and RSSIs is a set of RSSI values from multiple APs received during the fingerprinting. The RSSIs can be denoted as:

{<APⱼ, RSSIⱼ^{f}>}, j=1, . . . n (3)

In equation (3), RSSI is the RSSI value from APⱼ during the fingerprint with an offline device. In the online phase, the mobile device conducts a Wi-Fi scan and observes a set of RSSIs from multiple APs through the scan. The collected RSSI on an online device can be characterized as:

{<APⱼ, RSSIⱼ^{o}>}, j=1, . . . , n (4)

In equation (4), RSSIⱼ^{o} denotes the observed RSSI or the online device observation. In an exemplary embodiment of the disclosure, real-time RSSI offset calculation are conducted completely or partially by the online device. Calculations may also be done on a remote server (e.g., cloud server). The calculation begin by retrieving a set of fingerprint RSSI values (RSSIⱼ^{f}) from the fingerprint database and a set of observed RSSI values (RSSIⱼ^{o}) can be obtained when the mobile device scans available APs to collect RSSI therefrom.

For each set of fingerprint RSSI values, the online device will: (1) determining a RSSI offset (fpOff) in real-time by analyzing the fingerprint RSSI values (RSSIⱼ^{f}) and the observed RSSI values (RSSI^{o}); (2) apply the RSSI offset (fpOff) to the fingerprint RSSI values (RSSIⱼ^{f}) in the set to determine the adjusted RSSI fingerprint values; (3) compare the adjusted fingerprint values and observed RSSI values; (4) select the fingerprints whose adjusted RSSI values are closest to the observed RSSI values to determine an RSSI offset (obsOff) between offline and online device in current observation; (5) determine the RSSI offset (devOff) between offline and online device by weighted averaging the RSSI offset from current observation, RSSI offset from previous observations, RSSI offset between the two devices in cloud contributed by other online devices with same model; (6) apply the RSSI offset (devOff) to the RSSI values in each fingerprint to determine the new adjusted fingerprint RSSI values; (7) compare the adjusted fingerprint values and observed RSSI values; and (8) select the cells whose adjusted fingerprint RSSI values are closest to the observed RSSI values as the estimated location of the device. These steps are described below in the following exemplary procedure.

Determining RSSI Offset between each fingerprint and current observation—One of two exemplary methods can be used to calculate the RSSI Offset between the fingerprint and current observation (fpOff).

Exemplary Method 1 (Minimum Euclidean distance)—For each fingerprint in {FPᵢ}, calculate the minimum Euclidean distance between the fingerprint and current observation. In other words, we calculate a minimum value of below function:

ED(Off)=√Σⱼ₌₁ⁿ(RSSIⱼ^{o}−RSSIⱼ^{f}−Off)² (5)

In equation (5), Off is a variable of RSSI offset between current observation and the fingerprint. The minimum value of the function is denoted as fpED. The corresponding value of the variable Off is denoted as fpOff.

In order to find the minimum Euclidean distance fpED, the online device searches fpOff in a candidate RSSI offset set {offₖ}. For example, the online device may search a conservative candidate set {offₖ}={−15, −14, . . . , 0, . . . 15}, if no prior knowledge of actual fpOff exists. If the historical RSSI offset (historicalOff) are known from previous estimation or from a device RSSI offset database, the search can be conducted over a smaller subset {offₖ}, such as {historicalOff−2, historicalOff−1, . . . , historicalOff+2}. This provides a set of minimum ED for all fingerprints in {FPᵢ} as follows:

{fpEDᵢ}, i=1, . . . , m (6)

And correspondingly, a set of RSSI offsets for all fingerprints in {FPᵢ} as follows:

{fpOffᵢ}, i=(7)

In another embodiment the minimum Euclidean distance can be determined by setting finding the Off value which makes the functional derivative of ED(Off) zero. This Off value is can be the average of all (RSSIⱼ^{o}−RSSIⱼ^{f}). This embodiment is similar to method 2 described below.

Exemplary Method 2 (Average of Offset for Each AP)—The second exemplary method requires less computing power relative to the first exemplary method. Here, for each fingerprint in {FPᵢ}, the difference between observed RSSI value (RSSIⱼ^{o}) and fingerprint RSSI value (RSSIⱼ^{f}) is calculated from each AP in {APⱼ}:

{apOffⱼ=RSSIⱼ^{o}−RSSIⱼ^{f}}, j=1, . . . , n (8)

The RSSI offset for each fingerprint is an average value of all APs' offset as follows:

fpOff=Avg({apOffⱼ}) (9)

For the set {FPᵢ}, there will be a set of RSSI offset (fpOff) as follows:

{fpOffᵢ}, i=1, . . . , m (10)

Determining the Euclidean distance between adjusted RSSI values of each fingerprint and current observation—It should be noted that this step may not be implemented if Exemplary Method #1 (discussed above) is used as the Euclidean distance will have been calculated for each fingerprint in the method). Here, for each fingerprint the Euclidean distance between its adjusted RSSI values and current observed RSSI values are calculated as follows:

ED=√Σⱼ₌₁ⁿ(RSSIⱼ^{o}−RSSIⱼ^{f}−fpOff)² (11)

Thus, each set of {FPᵢ} will have a set of corresponding Euclidean distance (fpEDᵢ) as shown in equation (12):

{fpEDᵢ}, i=1, . . . , m (12)

Selecting one or multiple fingerprints which have minimum Euclidean distance to current observation—The minimum value in the set of {fpEDᵢ} in equation (12) is denoted as fpEDₓ and corresponding fpOffₓ is considered as the RSSI offset between observing device and the offline device from the following observation:

obsOff=fpOffₓ (13)

Alternatively, the multiple minimum values in {EDᵢ^{fp}} may be selected and an average value of their corresponding Offs be calculates as shown in equation (14):

obsOff=Avg(fpOffₓ₁, fpOffₓ₂, . . . ) (14)

Since fpOffₓᵢ is computed from the corresponding fingerprint entry FPi independently, the multiple minimum values {fpOffₓ₁, fpOffₓ₂, . . . } may contain inconsistent fpOff values. The inconsistency may be due to factors such as Wi-Fi signal variations and special AP layout. For example, in the set: {fpOffₓ₁, fpOffₓ₂, . . . }={−5, 4, 5, 6, 5}, the (−5 dB) is inconsistent with other values and is likely an outlier estimate. To make the obsOff estimation more robust, the outlier may be removed before computing Avg (fpOffₓ₁, fpOffₓ₂, . . . ). By way of example, the fpOffset values may be removed until the standard deviation of remaining {fpOffₓ₁, fpOffₓ₂, . . . } is below a small threshold (e.g., 3 dB). Alternatively, the a median value can be calculated to remove outliers:

obsOff=Median(fpOffₓ₁, fpOffₓ₂, . . . ) (15)

Calculating RSSI Offset between fingerprinting device and observing device—The RSSI Offset between fingerprinting device and observing device can be the offset of current observation calculated in last step:

devOff=obsOff (16)

In another embodiment, the devOff it can be a weighted average of current observation offset and historical offset as shown in equation (17):

devOff=w1*obsOff+w2*historicalOff (17)

In still another embodiment, the devOff can considered as the Offset in Cloud contributed by other devices with the same manufacture and model:

devOff=w1*obsOff+w2*historicalOff+w3*cloudOff (18)

where w1 is the weight of the RSSI Offset from current observation, w2 is the weight of historical data and w3 is the weight of the offset from Cloud.

Calculating the K—Nearest Neighbor (K-NN)—In this step, the sophisticated K-NN can be applied to estimate the location of the device. The Euclidean distance between each fingerprint and current observation is calculated as a function of the device RSSI Offset (devOff) as shown below:

ED=√Σⱼ₌₁ⁿ(RSSIⱼ^{o}−RSSIⱼ^{f}−devOff)² (19)

The cells whose Euclidian Distance are smallest to the current observation can be identified as the estimated location of the device.

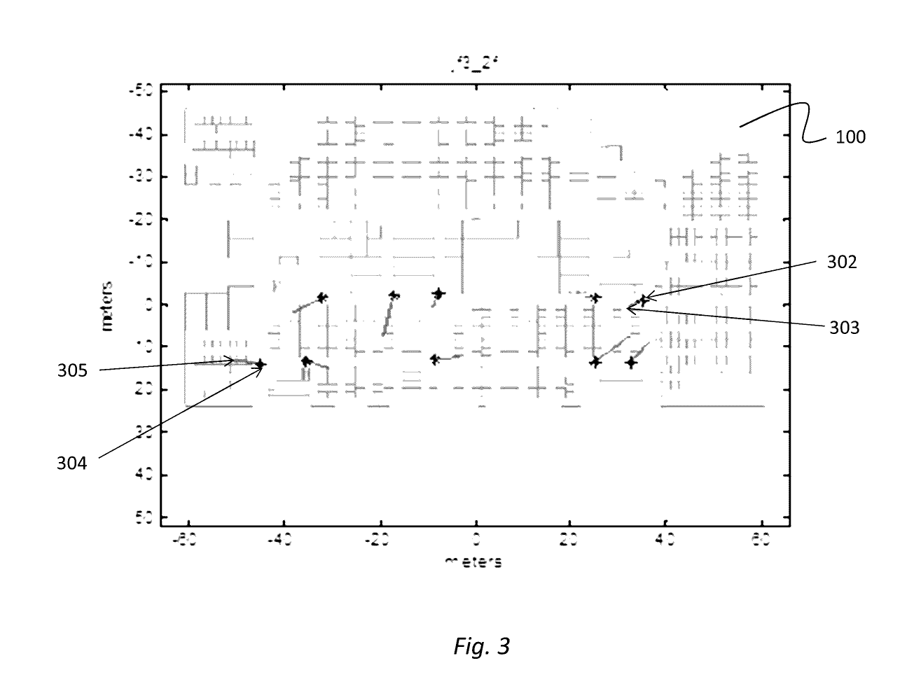

FIG. 3 shows the results of a real-time fingerprint location errors using the real-time implementation according to one embodiment of the disclosure. Specifically, the automatic calibration test was conducted using an online device configured to perform the above-described implementation. The same environment was used as in FIGS. 1 and 2. As can be readily seen from FIG. 3, the error vectors formed between actual locations (302, 304) and their corresponding measured locations (303, 305) is significantly smaller than those in FIG. 1 (no calibration) and roughly about the same distance as the manual calibration test results shown in FIG. 2. Advantageously, the real-time calibration test, the results of which are shown in FIG. 3, did not require manual calibration and can be performed with dynamically without any input requirement from the online device user's operation.

The online device may also calculate a device RSSI Offset relative to an offline (fingerprint) device based on the data from current and previous observations. Here, the device RSSI Offset can be uploaded to a database stored on a backend server (or the cloud) and combined with data from other devices with same model. Over time, the cloud-stored RSSI Offset (or remote-stored) between the two devices will be more comprehensive, accurate and stable. By way of example, the server can maintain a table for RSSI Offsets for different devices.

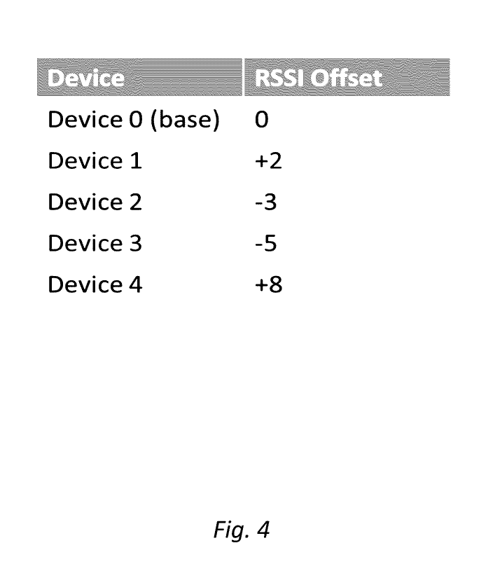

FIG. 4 is an exemplary table showing different RSSI offsets (in dBm) for different devices. In FIG. 4, each of Devices 0, 1, 2, 3 and 4 denotes a different wireless device make and model. The online device may identify its corresponding RSSI Offset from the exemplary table of FIG. 4 and quickly determine its accurate location within the environment.

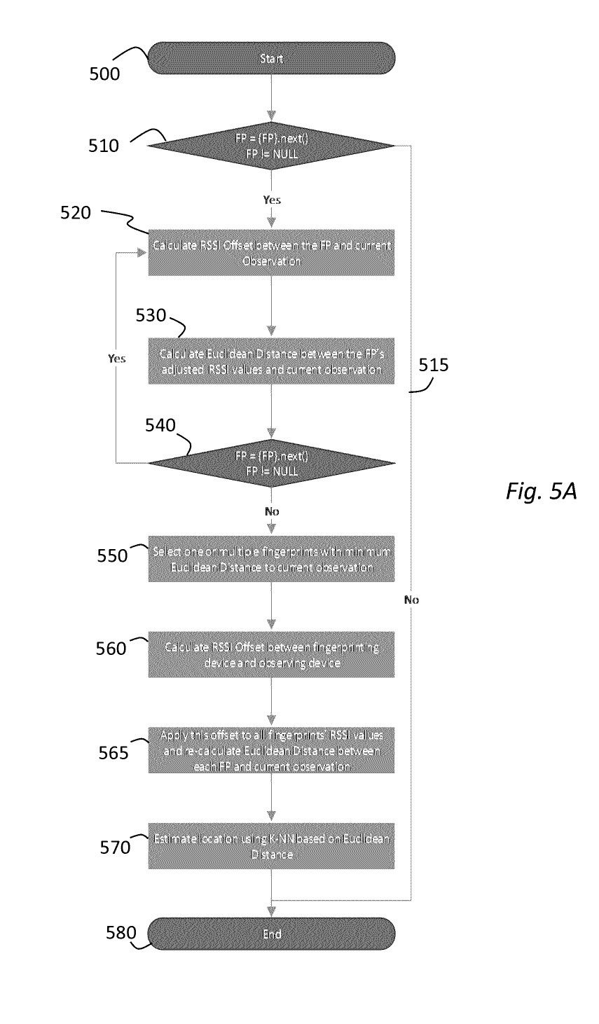

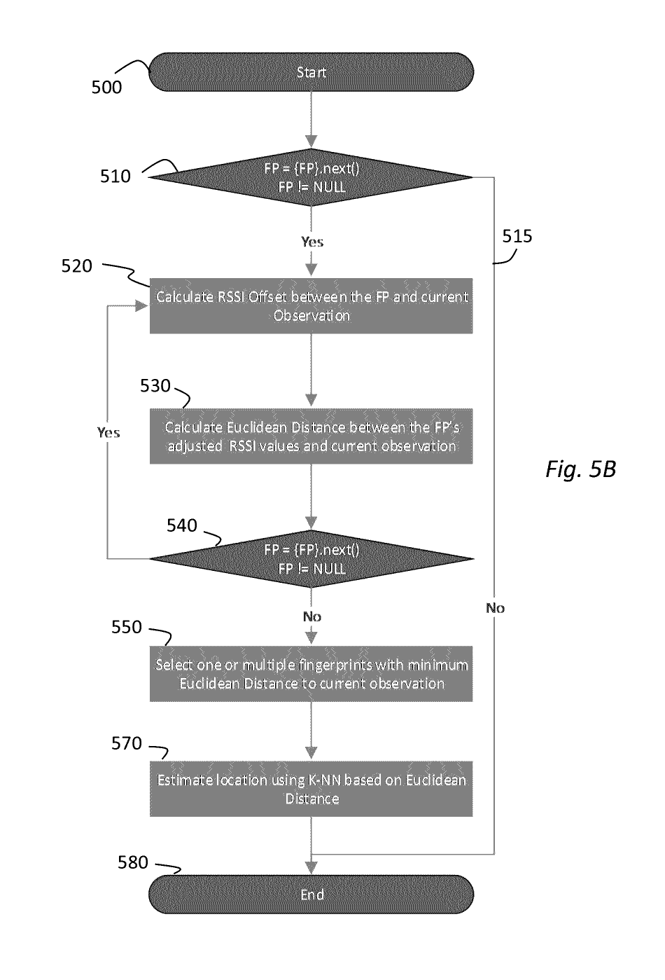

FIG. 5A shows an exemplary flow diagram for implementing one embodiment of the disclosure. The embodiment of FIG. 5A can be implemented entirely on the online device. In an alternative embodiment, one more steps of the flow diagram may be implemented at the online device while other steps are performed at a remote location such as a server, an AP or the cloud.

At step 500, the process starts when the online device scans its environment and identifies available APs. Once identified, the online (or the observing) device can measure and store an observed RSSI value for each AP. At step 510, a set of fingerprints is obtained. The fingerprints may be collected with an offline or a fingerprinting device. Each fingerprint includes a location where the fingerprint is done, a set of RSSI values from observable APs around the location and optionally a device/model on which the fingerprint is collected. The fingerprints may be stored at the online device or provided thereto from a remote database. If there are no fingerprints, the process ends as shown by arrow 515. At step 520, an RSSI offset value (fpOff) is calculated between each fingerprint and current observation.

At step 530, the Euclidean distance between the fingerprints' adjusted RSSI values and current observation's RSSI values is determined. At step 540, a decision is made as to whether all fingerprints in the set has been considered.

At step 550, one or more fingerprints are selected on the basis of having the closest Euclidean distance to the observed RSSI. At step 560, the RSSI offset between fingerprinting device (i.e., the offline device) and the online device is calculated. At step 565 the RSSI offset calculated between the fingerprinting device and the observing device (step 560) is applied to all fingerprints' RSSI values and the Euclidean distance between each fingerprint and current observation location is calculated. Finally, at step 570, the online device's location is determined. The K-NN method described above, or any equivalent method, may be used to determine the K-NN location. At step 580, the flow diagram ends.

FIG. 5B shows an exemplary flow diagram for a simplified implementation of FIG. 5A. The steps of FIG. 5B are substantially similar to those of FIG. 5A and are numbered similarly. The implementation of FIG. 5B is different in that it does not require the steps of calculating the RSSI offset between fingerprinting device and observing device (step 560) and applying the offset to all fingerprints' RSSI values to recalculate the Euclidean distance between each fingerprint and the observed locations. The process of FIG. 5B can be implemented entirely on the online device or some of the steps may be implemented at the online device while other steps are performed at a remote location.

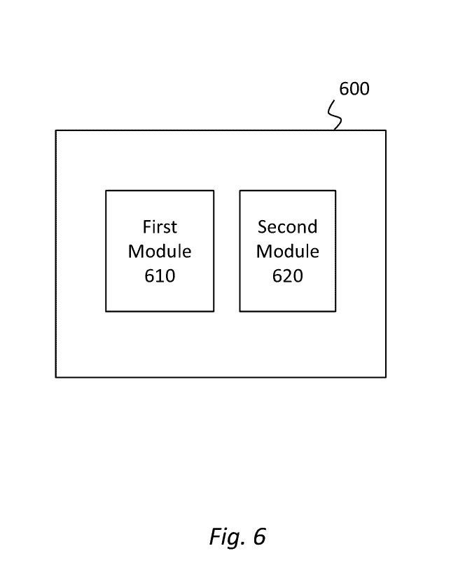

FIG. 6 schematically illustrates an exemplary device for implementing an embodiment of the disclosure. Specifically, FIG. 6 shows device 600 which can be an integral part of a larger system or can be a stand-alone unit. Device 600 may be any, or a combination, of a software, hardware, firmware or a system-on-chip configured to implement the disclosed methods. Device 600 may also be part of a larger system having one or more antennas, a radio and a memory system. For example, device 600 may be a processor programmed with instructions to conduct location measurement consistent with the disclosure.

Device 600 is shown with first module 610 and second module 620. Modules 610 and 620 may comprise hardware, software, firmware or any combination thereof. Further, each of module 610 and 620 can define one or more independent processor circuits. In an exemplary embodiment, at least one of modules 610 or 620 includes a processor circuit and a memory circuit (not shown) to communicate with each other and with other equipment (not shown). In still another embodiment, modules 610 and 620 may define different parts of the same data processing circuit. While not shown, other discrete or independent modules may be added to implement the embodiments disclosed herein.

In one embodiment, device 600 may be incorporated on the online device transparent form the user. For example, device 600 may define a software program or an applet configured to improve location determination accuracy. In an exemplary embodiment, first module 610 is configured to obtain data from a local AP scan. Device 600 may continuously scan for observable APs and identify multiple APs having different observed RSSI values. The first module 610 and the second module 620 can be configured to implement the steps disclosed herein. For example, first module 610 may be configured to measure a set of observed signal strength values (RSSI^{o}) from a plurality of observable APs. The first module can retrieve a plurality of fingerprints from a local or remote database. Each fingerprint may have a set of associated fingerprint signal strength values (RSSI^{f}). The fingerprint signal strength values can be previously collected from a plurality of known APs with different offline devices. The first module can then determine an RSSI device-offset value (devOff) between the online device and offline device.

Second module 620 may communicate with first module 610. Second module 620 can apply the RSSI device-offset value (devOff) to each of the fingerprint signal strength values (RSSI^{f}) to determine a plurality of adjusted RSSI values and calculate several Euclidean distances between each set of the adjusted RSSI values and the set of observed signal strength values. Once the Euclidean distances are determined, second module 620 can identify one or more fingerprints which have the smallest minimum Euclidian distance to the current observation. Second module 620 can use the locations of the identified fingerprints to determine the online device's location.

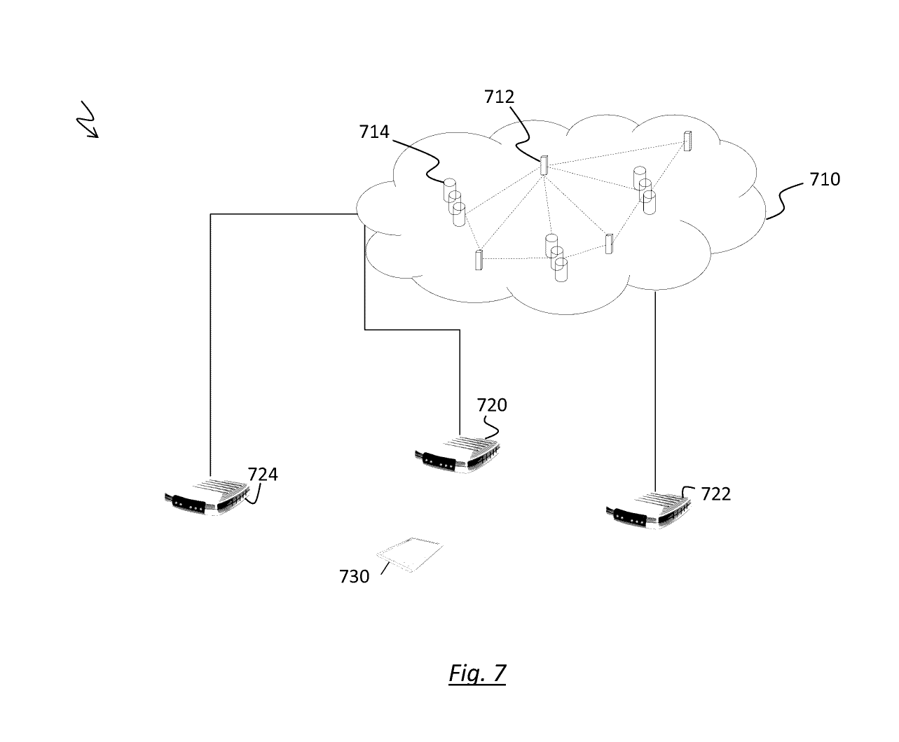

FIG. 7 is a schematic representation of an exemplary network for implementing the disclosed principals. Environment 700 includes APs 720, 722 and 724 which relay communication between cloud network 710 to STA 730. For illustrative purposes, STA 730 is shown as a tablet. However, the STAs may include cell phones, smartphones, laptops, tablets or any other radio device configured for location determination. In an exemplary embodiment, STA 730 includes one or more antennas, a radio and one or more modules configured to perform the disclosed embodiments. Each module may comprise a system on chip, a processor, a firmware, a software or an applet.

In one embodiment, STA 730 has radio and processing capability to implement the real-time location determination embodiments disclosed herein. AP 720, 722 and 724 are representative of multiple APs serving environment 700. Environment 700 may include more or less APs visible to STA 730. Each of AP 720, 722 and 724 may communicate directly with cloud 710 (as shown). Alternatively, one or more of the APs may relay signal from another AP.

Cloud 710 is shown with exemplary server 712 and databases 714. Databases 714 may contain offline fingerprint information which can be communicated to online device 730 through APs 720, 722 or 724. Alternatively, the offline fingerprint information may be uploaded to one or more of the APs or directly onto online device 730.

In one embodiment, online device 730 uses radio and antenna(s) to scan environment 700 to identify active APs. An existing applet may cause the online device to routinely scan for local APs. Once APs 720, 722 and 724 are identified, online device 730 can measure an observed signal strength value (RSSI^{o}) for signals received from each of APs 720, 722 and 724. Device 730 can be stationary or can be moving within environment 700. The device may observe different APs and/or with different signal strength (RSSI) at different times.

Online device 730 can retrieve a set of fingerprints recorded by an offline device for the APs. Each fingerprint includes a set of RSSI values (RSSI^{f}). Online device 730 may be further configured to determine real-time RSSI offset values (Off) between the observed signal strength values (RSSI^{o}) and the fingerprint signal strength value (RSSI^{f}) for each fingerprint. It may also determine the distance offset (ED(off)) as a function of the observed signal strength values, the fingerprint signal strength value and the real-time RSSI offset value (Off).

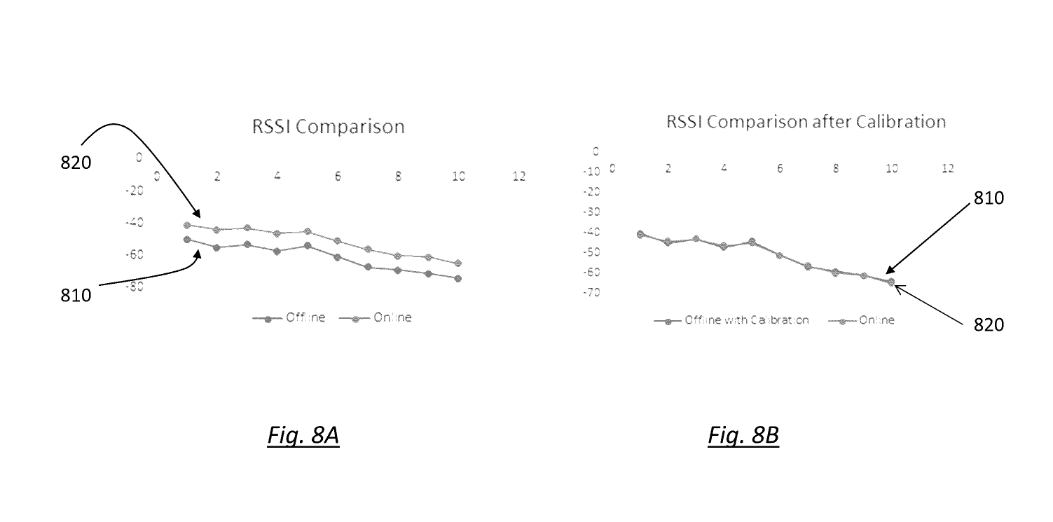

FIG. 8A shows location measurement for an uncalibrated online device and FIG. 8 B shows location measurement for a calibrated online device. Specifically, FIG. 8A shows RSSI comparison for an offline device 810 and an online device 820. Device 810 was not calibrated. FIG. 8A shows how the RSSIs look different on different devices even when they are located at substantially co-located. FIG. 8B, shows a similar measurement after the online device was calibrated according to an embodiment of the disclosure. Here, the two sets of RSSI values (i.e., the two curves) are significantly identical and closer in Euclidian distance.

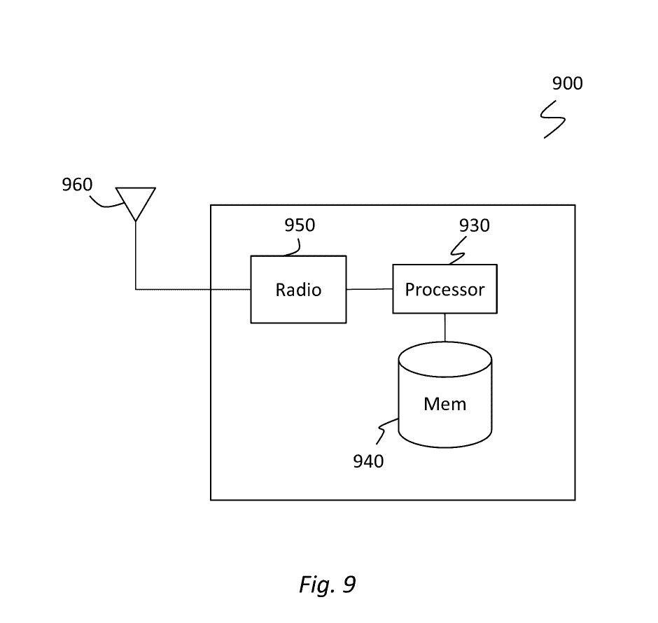

FIG. 9 shows an exemplary system for implementing the disclosure. System 900 of FIG. 9 may implement any of the disclosed calibration methods including the flow diagrams of FIGS. 5A and 5B. System 900 may also define any device used for automatic calibration. While system 900 is shown with antenna 960, the disclosure is not limited to having one antenna. Multiple antennas can be added to system 900 such that different signals for different protocols can be received at different antennas. The signal(s) received at antenna 960 can be relayed to radio 950. Radio 950 may include transceiver components such as front-end receiver components or a receiver/transmitter.

Radio 950 can communicate signal information, which may include to processor 930. Processor 930 may include one or more modules as discussed in relation to FIG. 6. Processor 930 also communicates with database memory circuit 940. While shown as a separate circuitry in the system 900, it should be noted that instructions can be embedded on processor 930 as firmware to obviate the addition of memory circuit 940.

Memory 940 may contain instructions for processor 930 to implement one or more of the steps of an exemplary method outlined above. Memory 940 may define a non-transitory computer readable medium to direct processor 930 (or a module thereof) with instructions to conduct an automatic calibration process. Once obtained, the calibration information may be stored at memory 940. Memory 940 may also instruct processor 930 (or a module thereof) to conduct additional calibration operations.

The following examples pertain to further embodiments of the disclosure. Example 1 includes a for real-time location determination of an online device, the method comprising: measuring, at the online device, a set of observed signal strength values (RSSI^{o}) from a plurality of observable access points (APs); retrieving a plurality of fingerprints collected by an offline device, each fingerprint having a set of fingerprint signal strength values (RSSI^{f}) from the plurality of observable APs; determining an RSSI device-offset value (devOff) based on the signal strength values measured by the online device and the signal strength values collected by the; applying the RSSI device-offset value (devOff) to each of the fingerprint signal strength values (RSSI^{f}) to determine a plurality of adjusted RSSI values; and calculating a plurality of Euclidean distances between each set of the plurality of adjusted RSSI values and the set of observed signal strength values.

Example 2 includes the method of example 1, further comprising identifying one or more fingerprint locations having a minimum Euclidian Distance from the plurality of calculated Euclidean distance.

Example 3 includes the method of example 1, further comprising measuring a set of signal strength values (RSSI^{o}) from multiple observable APs at an unknown location.

Example 4 includes the method of example 1 or 2, wherein the set of fingerprints is recorded by an offline device at a plurality of known locations.

Example 5 includes the method of example 4, further comprising: determining a real-time RSSI observation-offset (obsOff) value as a function of the set of signal strength values from the offline device (RSSI^{f}) and the online device (RSSI^{o}); and determining the RSSI device-offset (devOff) value as a function of the RSSI observation-offset (obsOff) values and at least one RSSI offset value determined by another substantially similar device.

Example 6 includes the method of example 1 or 2, further comprising determining a location for the online device as a function of the identified fingerprint locations.

Example 7 includes the method of example 1 or 2, further comprising: for each fingerprint, determining a real-time RSSI fingerprint-offset (fpOff) between the fingerprint signal strength values (RSSI^{f}) and the observed signal strength values (RSSI^{o}); for each fingerprint, applying the real-time RSSI fingerprint-offset (fpOff) to the fingerprint signal strength values (RSSI^{f}) to obtain a set of adjusted fingerprint RSSI values; for each fingerprint, calculating a Euclidean distance between the set of adjusted fingerprint RSSI values and the observed signal strength values (RSSI^{o}); identifying one or multiple fingerprints with a minimum Euclidian Distance; and determining a real-time RSSI observation-offset (obsOff) as a function of the fingerprint-offset (fpOff) associated with the identified fingerprints having the minimum Euclidian Distance.

Example 8 includes the method of example 3, further comprising: determining an RSSI ap-offset (apOff) value for a first AP based on a signal strength value received on the online device (RSSI^{o}) and a corresponding signal strength value received on the offline device (RSSI^{f}); and determining an RSSI fingerprint-offset (fpOff), for the fingerprint, as a function of the RSSI ap-offset (apOff) for all APs.

Example 9 includes the method of example 1 or 2 further comprising providing a database containing RSSI offset values for a plurality of online devices, the database configured provide the RSSI offset value between the online device and a known offline device.

Example 10 is directed to a device for real-time location determination, comprising: a first module to determine an RSSI device-offset value (devOff) and a plurality of adjusted RSSI values, the (devOff) determined as a function of a set of observed signal strength (RSSI^{o}) values and at least one set of fingerprint signal strength values (RSSI^{f}); a second module to determine a minimum Euclidian Distance between the plurality of adjusted RSSI values and the set of observed signal strength (RSSI^{o}) values.

Example 11 is directed to the device of example 10, wherein the first modules is further configured to retrieve at least one set of fingerprint signal strength values (RSSI^{f}) from a database.

Example 12 is directed to device of example 10, wherein one of the first or the second module is further configured to determine a real-time RSSI observation-offset (obsOff) value as a function of the fingerprint signal strength values (RSSI^{f}) and the observed signal strength values (RSSI^{o}); and determine the RSSI device-offset (devOff) value as a function of the RSSI observation-offset (obsOff) value and at least one RSSI offset value determined by another substantially similar device.

Example 13 is directed to the device of example 10, wherein one of the first or the second module is further configured to: for each fingerprint, determine a real-time RSSI fingerprint-offset (fpOff) between the fingerprint signal strength values (RSSI^{f}) and the observed signal strength values (RSSI^{o}); apply the real-time RSSI fingerprint-offset (fpOff) to the fingerprint signal strength values (RSSI^{f}) to obtain a set of adjusted fingerprint RSSI values; calculate a

Euclidean distance between the set of adjusted fingerprint RSSI values and the observed signal strength values (RSSI^{o}); identify one or multiple fingerprints with a minimum Euclidian Distance; and determine a real-time RSSI observation-offset (obsOff) as a function of the fingerprint-offset (fpOff) associated with the identified fingerprints having the minimum Euclidian Distance.

Example 14 is directed to the device of example 10, wherein one of the first or the second module is further configured to determine an RSSI ap-offset (apOff) for at least one access point (AP) identified both in a fingerprint database and in real-time observation, and determine an RSSI fingerprint-offset (fpOff), for the fingerprint as a function of the RSSI ap-offset (apOff) for all APs.

Example is directed to a system for real-time location determination, comprising: a radio; one or more antennas to communicate with the radio; a processor in communication with the radio, the processor having a first module and a second module, a first module configured to determine an RSSI device-offset value (devOff) and a plurality of adjusted RSSI values, the (devOff) determined as a function of a set of observed signal strength (RSSI^{o}) values and a set of fingerprint signal strength values (RSSI^{f}), and the second module configured to determine a minimum Euclidian Distance between the plurality of adjusted RSSI values and the set of observed signal strength (RSSI^{o}) values.

Example 16 is directed to the system of example 15, further comprising a database to provide a plurality of fingerprint sets having signal strength values (RSSI^{f}).

Example 17 is directed to the system of example 15, wherein the first modules is further configured to retrieve the set of fingerprint signal strength values (RSSI^{f}) from a database.

Example 18 is directed to the system of example 15, wherein one of the first or the second module is further configured to determine a real-time RSSI observation-offset (obsOff) value as a function of sets of signal strength values from the offline device (RSSI^{f}) and the online device) (RSSI^{o}); and determine the RSSI device-offset (devOff) value as a function of the RSSI observation-offset (obsOff) value and at least one RSSI offset value determined by another substantially similar device.

Example 19 is directed to the system of example 15, wherein one of the first or the second module is further configured to: determine a real-time RSSI fingerprint-offset (fpOff) between the fingerprint signal strength values (RSSI^{f}) and the observed signal strength values(RSSI^{o}); apply the real-time RSSI fingerprint-offset (fpOff) to the fingerprint signal strength values (RSSI^{f}) to obtain a set of adjusted fingerprint RSSI values; calculate a Euclidean distance between the set of adjusted fingerprint RSSI values and the observed signal strength values) (RSSI^{o}); identify one or multiple fingerprints with a minimum Euclidian Distance; and determining a real-time RSSI observation-offset (obsOff) as a function of the fingerprint-offset (fpOff) associated with the identified fingerprints having the minimum Euclidian Distance.

Example 20 is directed to the system of example 15, wherein one of the first or the second module is further configured to determine an RSSI ap-offset (apOff), for each AP observed with the offline device in a fingerprint database and with the online device a in real-time observation;

and determine an RSSI fingerprint-offset (fpOff), for the fingerprint as a function of the RSSI ap-offset (apOff) for all APs.

Example 21 is directed to the system of example 15, wherein one of the first module or the second module is further configured to communicate with an external database through the antenna to retrieve provide the set of fingerprint signal strength values (RSSI^{f}).

Example 22 is directed to the system of example 15, further comprising a memory circuit for storing the RSSI device-offset value.

Example 23 is directed to a computer-readable storage device containing a set of instructions to cause a computer to perform a process to determine an online device location, the instructions comprising: measure a set of observed signal strength values (RSSI^{o}) from a plurality of observable access points (APs); obtain a plurality of fingerprints, each fingerprint having a set of fingerprint signal strength values (RSSI^{f}) from the plurality of APs; determine an RSSI device-offset value (devOff) between the offline device and online device; apply the RSSI device-offset value (devOff) to each of the fingerprint signal strength values (RSSI^{f}) values to determine a plurality of adjusted RSSI values; calculate a plurality of Euclidean distances between each set of the plurality of adjusted RSSI values and the set of observed signal strength values; identify one or more fingerprint locations having a minimum Euclidian Distance; and determine a location for the online device as a function of the identified fingerprint locations.

Example 24 is directed to the computer-readable storage device of example 23, wherein the instructions further comprise: determine a real-time RSSI observation-offset (obsOff) value as a function of the sets of signal strength values from the offline device (RSSI^{f}) and the online device (RSSI^{o}); and determine the RSSI device-offset (devOff) value as a function of the RSSI observation-offset (obsOff) value and at least one RSSI offset value determined by another substantially similar device.

Example 25 is directed to the computer-readable storage device of example 23, wherein the instructions further comprise: determine a real-time RSSI fingerprint-offset (fpOff) between the fingerprint signal strength values (RSSI^{f}) and the observed signal strength values (RSSI^{f}); apply the real-time RSSI fingerprint-offset (fpOff) to the fingerprint signal strength values (RSSI) to obtain a set of adjusted fingerprint RSSI values; calculate a Euclidean distance between the set of adjusted fingerprint RSSI values and the observed signal strength values (RSSI^{o}); identify one or multiple fingerprints with a minimum Euclidian Distance; and determine a real-time RSSI observation-offset (obsOff) as a function of the fingerprint-offset (fpOff) associated with the identified fingerprints having the minimum Euclidian Distance.

While the principles of the disclosure have been illustrated in relation to the exemplary embodiments shown herein, the principles of the disclosure are not limited thereto and include any modification, variation or permutation thereof.

1. A method for real-time location determination of an online device, the method comprising:
measuring, at the online device, a set of observed signal strength values (RSSI^{o}) from a plurality of observable access points (APs);
retrieving a plurality of fingerprints collected by an offline device, each fingerprint having a set of fingerprint signal strength values (RSSI^{f}) from the plurality of observable APs;
determining an RSSI device-offset value (devOff) based on the signal strength values measured by the online device and the signal strength values collected by the offline device;
applying the RSSI device-offset value (devOff) to each of the fingerprint signal strength values (RSSI^{f}) to determine a plurality of adjusted RSSI values; and
calculating a plurality of Euclidean distances between each set of the plurality of adjusted RSSI values and the set of observed signal strength values.

2. The method of claim 1, further comprising identifying one or more fingerprint locations having a minimum Euclidian Distance from the plurality of calculated Euclidean distance.

3. The method of claim 1, further comprising measuring a set of signal strength values (RSSI^{o}) from multiple observable APs at an unknown location.

4. The method of claim 1, wherein the set of fingerprints is recorded by an offline device at a plurality of known locations.

5. The method of claim 4, further comprising:
determining a real-time RSSI observation-offset (obsOff) value as a function of the set of signal strength values from the offline device (RSSI^{f}) and the online device (RSSI^{o}); and
determining the RSSI device-offset (devOff) value as a function of the RSSI observation-offset (obsOff) values and at least one RSSI offset value determined by another substantially similar device.

6. The method of claim 1, further comprising determining a location for the online device as a function of the identified fingerprint locations.

7. The method of claim 1, further comprising:
for each fingerprint, determining a real-time RSSI fingerprint-offset (fpOff) between the fingerprint signal strength values (RSSI^{f}) and the observed signal strength values (RSSI^{o});
for each fingerprint, applying the real-time RSSI fingerprint-offset (fpOff) to the fingerprint signal strength values (RSSI^{f}) to obtain a set of adjusted fingerprint RSSI values;
for each fingerprint, calculating a Euclidean distance between the set of adjusted fingerprint RSSI values and the observed signal strength values (RSSI^{o});
identifying one or multiple fingerprints with a minimum Euclidian Distance; and
determining a real-time RSSI observation-offset (obsOff) as a function of the fingerprint-offset (fpOff) associated with the identified fingerprints having the minimum Euclidian Distance.

8. The method of claim 3, further comprising:
determining an RSSI ap-offset (apOff) value for a first AP based on a signal strength value received on the online device (RSSI^{o}) and a corresponding signal strength value received on the offline device (RSSI^{f}); and
determining an RSSI fingerprint-offset (fpOff), for the fingerprint, as a function of the RSSI ap-offset (apOff) for all APs.

9. The method of claim 1, further comprising providing a database containing RSSI offset values for a plurality of online devices, the database configured provide the RSSI offset value between the online device and a known offline device.

10. A device for real-time location determination, comprising:
a first module to determine an RSSI device-offset value (devOff) and a plurality of adjusted RSSI values, the (devOff) determined as a function of a set of observed signal strength) (RSSI^{o}) values and at least one set of fingerprint signal strength values (RSSI^{f});
a second module to determine a minimum Euclidian Distance between the plurality of adjusted RSSI values and the set of observed signal strength (RSSI^{o}) values.

11. The device of claim 10, wherein the first modules is further configured to retrieve at least one set of fingerprint signal strength values (RSSI^{f}) from a database.

12. The device of claim 10, wherein one of the first or the second module is further configured to determine a real-time RSSI observation-offset (obsOff) value as a function of the fingerprint signal strength values (RSSI^{f}) and the observed signal strength values (RSSI^{o}); and determine the RSSI device-offset (devOff) value as a function of the RSSI observation-offset (obsOff) value and at least one RSSI offset value determined by another substantially similar device.

13. The device of claim 10, wherein one of the first or the second module is further configured to: for each fingerprint, determine a real-time RSSI fingerprint-offset (fpOff) between the fingerprint signal strength values (RSSI^{f}) and the observed signal strength values) (RSSI^{o}); apply the real-time RSSI fingerprint-offset (fpOff) to the fingerprint signal strength values (RSSI^{f}) to obtain a set of adjusted fingerprint RSSI values; calculate a Euclidean distance between the set of adjusted fingerprint RSSI values and the observed signal strength values (RSSI^{o}); identify one or multiple fingerprints with a minimum Euclidian Distance; and
determine a real-time RSSI observation-offset (obsOff) as a function of the fingerprint-offset (fpOff) associated with the identified fingerprints having the minimum Euclidian Distance.

14. The device of claim 10, wherein one of the first or the second module is further configured to determine an RSSI ap-offset (apOff) for at least one access point (AP) identified both in a fingerprint database and in real-time observation, and determine an RSSI fingerprint-offset (fpOff), for the fingerprint as a function of the RSSI ap-offset (apOff) for all APs.

15. A system for real-time location determination, comprising:
a radio;
one or more antennas to communicate with the radio;
a processor in communication with the radio, the processor having a first module and a second module, a first module configured to determine an RSSI device-offset value (devOff) and a plurality of adjusted RSSI values, the (devOff) determined as a function of a set of observed signal strength (RSSI^{o}) values and a set of fingerprint signal strength values (RSSI^{f}), and the second module configured to determine a minimum Euclidian Distance between the plurality of adjusted RSSI values and the set of observed signal strength (RSSI^{o}) values.

16. The system of claim 15, further comprising a database to provide a plurality of fingerprint sets having signal strength values (RSSI^{f}).

17. The system of claim 15, wherein the first modules is further configured to retrieve the set of fingerprint signal strength values (RSSI^{f}) from a database.

18. The system of claim 15, wherein one of the first or the second module is further configured to determine a real-time RSSI observation-offset (obsOff) value as a function of sets of signal strength values from the offline device (RSSI^{f}) and the online device (RSSI^{o});
and determine the RSSI device-offset (devOff) value as a function of the RSSI observation-offset (obsOff) value and at least one RSSI offset value determined by another substantially similar device.

19. The system of claim 15, wherein one of the first or the second module is further configured to: determine a real-time RSSI fingerprint-offset (fpOff) between the fingerprint signal strength values (RSSI^{f}) and the observed signal strength values (RSSI^{o}); apply the real-time RSSI fingerprint-offset (fpOff) to the fingerprint signal strength values (RSSI^{f}) to obtain a set of adjusted fingerprint RSSI values; calculate a Euclidean distance between the set of adjusted fingerprint RSSI values and the observed signal strength values (RSSI^{o}); identify one or multiple fingerprints with a minimum Euclidian Distance; and determining a real-time RSSI observation-offset (obsOff) as a function of the fingerprint-offset (fpOff) associated with the identified fingerprints having the minimum Euclidian Distance.

20. The system of claim 15, wherein one of the first or the second module is further configured to determine an RSSI ap-offset (apOff), for each AP observed with the offline device in a fingerprint database and with the online device a in real-time observation; and determine an RSSI fingerprint-offset (fpOff), for the fingerprint as a function of the RSSI ap-offset (apOff) for all APs.

21. The system of claim 15, wherein one of the first module or the second module is further configured to communicate with an external database through the antenna to retrieve provide the set of fingerprint signal strength values (RSSI^{f}).

22. The system of claim 15, further comprising a memory circuit for storing the RSSI device-offset value.

23. A computer-readable storage device containing a set of instructions to cause a computer to perform a process to determine an online device location, the instructions comprising:
measure a set of observed signal strength values (RSSI^{o}) from a plurality of observable access points (APs);
obtain a plurality of fingerprints, each fingerprint having a set of fingerprint signal strength values (RSSI^{f}) from the plurality of APs;
determine an RSSI device-offset value (devOff) between the offline device and online device;
apply the RSSI device-offset value (devOff) to each of the fingerprint signal strength values (RSSI^{f}) values to determine a plurality of adjusted RSSI values;
calculate a plurality of Euclidean distances between each set of the plurality of adjusted RSSI values and the set of observed signal strength values;
identify one or more fingerprint locations having a minimum Euclidian Distance; and
determine a location for the online device as a function of the identified fingerprint locations.

24. The computer-readable storage device of claim 23, wherein the instructions further comprise: determine a real-time RSSI observation-offset (obsOff) value as a function of the sets of signal strength values from the offline device (RSSI^{f}) and the online device (RSSI^{o}); and determine the RSSI device-offset (devOff) value as a function of the RSSI observation-offset (obsOff) value and at least one RSSI offset value determined by another substantially similar device.

25. The computer-readable storage device of claim 23, wherein the instructions further comprise: determine a real-time RSSI fingerprint-offset (fpOff) between the fingerprint signal strength values (RSSI^{f}) and the observed signal strength values (RSSI^{o}); apply the real-time RSSI fingerprint-offset (fpOff) to the fingerprint signal strength values (RSSI^{f}) to obtain a set of adjusted fingerprint RSSI values; calculate a Euclidean distance between the set of adjusted fingerprint RSSI values and the observed signal strength values (RSSI^{o}); identify one or multiple fingerprints with a minimum Euclidian Distance; and determine a real-time RSSI observation-offset (obsOff) as a function of the fingerprint-offset (fpOff) associated with the identified fingerprints having the minimum Euclidian Distance.
